(19) United States
(12) Patent Application Publication
(10) Pub. No.: US 2013/0036138 A1
(43) Pub. Date: Feb. 7, 2013

(54) SYSTEMS AND METHODS FOR E-MAIL-BASED CUSTOMER RELATIONSHIP MANAGEMENT

(71) Applicants: Matthew Bellows, Watertown, MA (US); Patrick Andrus, Florianopolis (BR)

(72) Inventors: Matthew Bellows, Watertown, MA (US); Patrick Andrus, Florianopolis (BR)

(21) Appl. No.: 13/564,059

(22) Filed: Aug. 1, 2012

Related U.S. Application Data
(60) Provisional application No. 61/513,823, filed on Aug. 1, 2011.

(51) Int. Cl. G06F 17/30

(52) U.S. Cl. 707/772; 707/E17.014

(57) ABSTRACT

Representative embodiments of a system for managing customer-relationship activities and knowledge include a template database for storing a plurality of templates, each corresponding to a business activity and comprising text relating to the business activity, an application enabling user selection of a template and formatting of an e-mail conforming to the template, a tracking database for storing and aggregating the user selections, and an interface for permitting querying of the tracking database to obtain data relevant to at least one user or at least one business activity at a specified level of aggregation.

### CROSS-REFERENCE TO RELATED APPLICATION

This application claims priority to and the benefit of, and incorporates herein by reference in its entirety, U.S. Provisional Patent Application No. 61/513,823, which was filed on Aug. 1, 2011.

### FIELD OF THE INVENTION

In various embodiments, the present invention relates generally to systems and methods for managing customer relationships.

### BACKGROUND

Marketing personnel and people working in customer-facing roles—such as sales, customer support, or technical support—need to act quickly and decisively to succeed in today's competitive marketplace. Information related to the customers and available to corporations continues to increase rapidly and is frequently overwhelming. Recently, various applications relating to customer relationship management (“CRM”) have been developed to help users manage customers' information by organizing data and standardizing business processes; the goals are to efficiently find, attract, and win new clients, nurture and retain those the organization currently has, entice former clients back into the fold, and reduce the costs of marketing and client service. If a CRM system is fully utilized by an organization's staff, the organization's management can, for example, access data on individual and group performance; such data may provide insights into the strengths and vulnerabilities of products and/or services, complaints, and customer reaction to new pricing structures or features are being.

A CRM system typically includes one or more databases that store an organization's interactions with customers and clients, communications, deals, and prospects and an input device and interface that facilitate population of the database as well as extraction of data therefrom. One of the largest challenges facing CRM systems is poor usability due to cumbersome interfaces. Lack of a “user friendly” interface leads to utilization of only certain features of the CRM system, while other features are neglected. Additionally, conventional CRM systems generally require opening multiple windows and/or copying-and-pasting relevant data from the CRS system to applications that facilitate users' day-to-day tasks. This significantly hinders the effectiveness of the CRM system and diminishes the benefits of the CRM system to the organization's management.

Consequently, there is a need for a CRM system that can be integrated with users' daily workflow (e.g., communication with the clients) and provide a user-friendly interface to increase utilization of all CRM functions.

### SUMMARY

Embodiments of the present invention relate to systems and methods that integrate CRM system functionality into a user interface (e.g., an e-mail interface) of an application that facilitates users' daily tasks (e.g., communicating with the clients). In various embodiments, CRM templates are loaded in an e-mail service using an e-mail package in the CRM system, and as these templates are selected, they and/or their contents are mined for data relevant to the CRM functions. For example, a user may select a template that includes text relating to a business activity; the selected template formats an e-mail for the user in an e-mail client application. This provides an easy way for the user to quickly and consistently communicate with the clients while the fact and nature of the communication is analyzed for CRM purposes. The user-selected templates may be stored and aggregated in a tracking database that can be accessed by administration personnel to obtain information about, for example, the organization's interactions with customers and clients, or sales prospects in real time; timely decisions can then be made if necessary. In addition, data relevant to the users and/or the business activities stored in the tracking database may be manually or automatically analyzed to identify anomalies that relate to, for example, a CRM function, a product, a customer, or the users. The term “anomaly” is herein used broadly to connote any deviation from expectations that provides useful information for a business organization. An anomaly may be, for example, a dissatisfied customer, a malfunctioning product, or an inappropriate message sent by a salesperson. More broadly, it can be an activity level or emphasis that deviates from a desired or average level among a user's peers. For example, if a salesperson sends too many e-mails to prospective customers relative to the number sent to existing customers, he/she may be neglecting relationships in favor of prospecting; knowing this helps the organization quickly identify the salesperson's undesired emphasis as well as the potentially affected customers, thereby facilitating both feedback to the salesperson as well as flagging the affected customers for communication (e.g., by other members of the sales team). Similarly, an anomaly can be a level of effort (e.g., the number of customer e-mails sent out by a particular salesperson over a given period relative to an expected norm or peer average) or a success level; success may be measured using feedback based on the recipient's actions following receipt of the e-mail. Most simply, an application in accordance herewith may match incoming e-mails with those sent by the user in order to detect, for example, how many customers replied to a salesperson's messages and how quickly. Using return receipts or other e-mail tracking techniques, it is also possible to determine how quickly the recipient opened the e-mail, whether it was forwarded to others, etc. Such data can be quite useful in gauging a salesperson's effectiveness in communication and in building strong customer relationships.

An integrated e-mail-based CRM system in accordance with various embodiments of the invention thus provides a friendly, familiar interface for the users to facilitate CRM functions and communicate with the clients. Additionally, because it is possible to display a single window that integrates CRM functions into an e-mail interface, the inconvenience of copying and pasting data between multiple windows or multiple software applications is eliminated.

Accordingly, in one aspect, the invention pertains to a system for managing customer-relationship activities and knowledge. In representative embodiments, the system includes a template database for storing multiple templates that correspond to business activities and include text relating thereto, a processor-executed application enabling user selection of a template and formatting of an e-mail, in an e-mail client application, conforming to the template, a tracking database for storing and aggregating the user template selections, and an interface for permitting querying of the tracking database to obtain data relevant to one or more users or one or more business activities at a specified level of aggregation. The specified level of aggregation may be a person, a group, an entire organization, or a business activity.

In various embodiments, the system includes a processor-executed analytical engine for analyzing the user selections and, based on the selections and the business activities associated therewith, identifying anomalies. The anomalies may relate to a CRM function. For example, the anomalies may relate to a product, a customer, a salesperson, and/or a sales group.

In some embodiments, the template database associates, with each template, one or more tags indicating a category and/or an action. The templates may be customizable by a user or an administrator. The e-mail may be formatted by applying an e-mail package to the user's e-mail client application.

In one embodiment, the system includes a second interface for accessing an external CRM account in an external CRM database or accessing the external CRM database for providing additional templates to the user.

In a second aspect, the invention relates to a method for managing e-mail templates. In various embodiments, the method includes the steps of storing multiple templates corresponding to business activities and including text relating thereto, enabling user selection of a template and formatting of an e-mail, in an e-mail client application, conforming to the template, storing and aggregating the user selections, and facilitating querying of the tracking database to obtain data relevant to one or more users or one or more business activities at a specified level of aggregation. In one embodiment, the method includes tagging each template with a category and/or an action.

The method may include analyzing the user selections and, based on the selections and the business activities associated therewith, identifying anomalies. The method may further include storing a template in an external CRM account in an external CRM database. In various embodiments, the method includes accessing the external CRM database for providing additional templates. In one implementation, the e-mail client application includes a single window displaying the formatted e-mail.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 illustrates a CRM system in accordance with embodiments of the current invention;

FIG. 2 illustrates a CRM system integrated into an e-mail service;

FIG. 3A depicts exemplary templates presented and listed next to the category selected by the users;

FIG. 3B depicts a customized template;

FIG. 3C depicts a newly created template;

FIG. 3D depicts a template including text fields where the users modify and/or add text to tailor the e-mail to the relevant circumstances;

FIG. 3E illustrates a template saved to an external CRM database; and

FIG. 4 depicts a method of utilizing a CRM system integrated with a user communication application in accordance with embodiments of the current invention.

### DETAILED DESCRIPTION

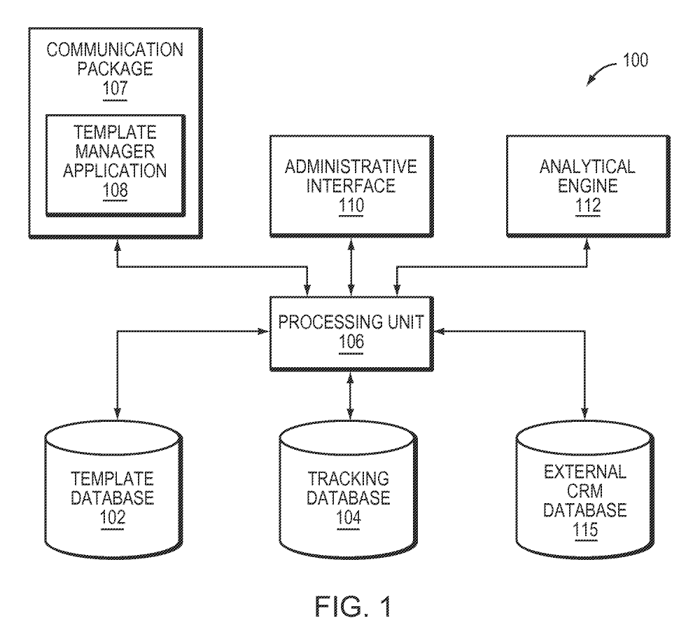

FIG. 1 depicts an exemplary CRM system 100 that may be integrated into an application facilitating users' daily tasks. Templates that correspond to business activities (e.g., sales activities, marketing, customer service, or technical support) are stored in a template database 102. Upon selection by a user, or other related selections made by the user, the selected templates are logged and stored in a tracking database 104. System operations, including reading from and writing to the databases 102, 104, are carried out by a conventional computer processing unit 106. The processing unit 106 may execute a communication package (e.g., an e-mail package) 107 that loads a template manager application 108 as an interface in a client communication application (e.g., e-mail), thereby integrating the CRM system into the communication application. Via the integrated interface, users readily access the templates stored in the template database 102. The template manager application 108 also interacts, via the processing unit 106, with the tracking database 104, for example, to record the selection and use of templates by the users. In some embodiments, the system 100 includes an administrative interface 110 that allows managers and administrators to create, update, and manage templates in the template database 102 and/or access template usage and tracking data stored in the tracking database 104. In various embodiments, the system 100 includes an analytical engine 112 that can access and analyze the templates in the template database 102 and/or the tracking data and selected templates stored in the tracking database 104 according to criteria selected by system administrators—e.g., by users (employees), user groups, customers, template category, or products. In one embodiment, the CRM system 100 interfaces with an external CRM database 115 to provide additional CRM templates to the users.

As used herein, the term “database” refers broadly to any suitable platform for digital data storage, management and retrieval. The database may involve local, remote or distributed computer storage, and may be virtual in the sense of not being physically tied to a single machine or database instance; that is, there may be many different instances of, for example, tracking databases on different machines (for load balancing, for support of different metrics to track, etc.) that collectively represent the tracking database 104. Conversely, the various databases described herein can be realized within a single database system, appliance, or even instance, depending on scale and design choice.

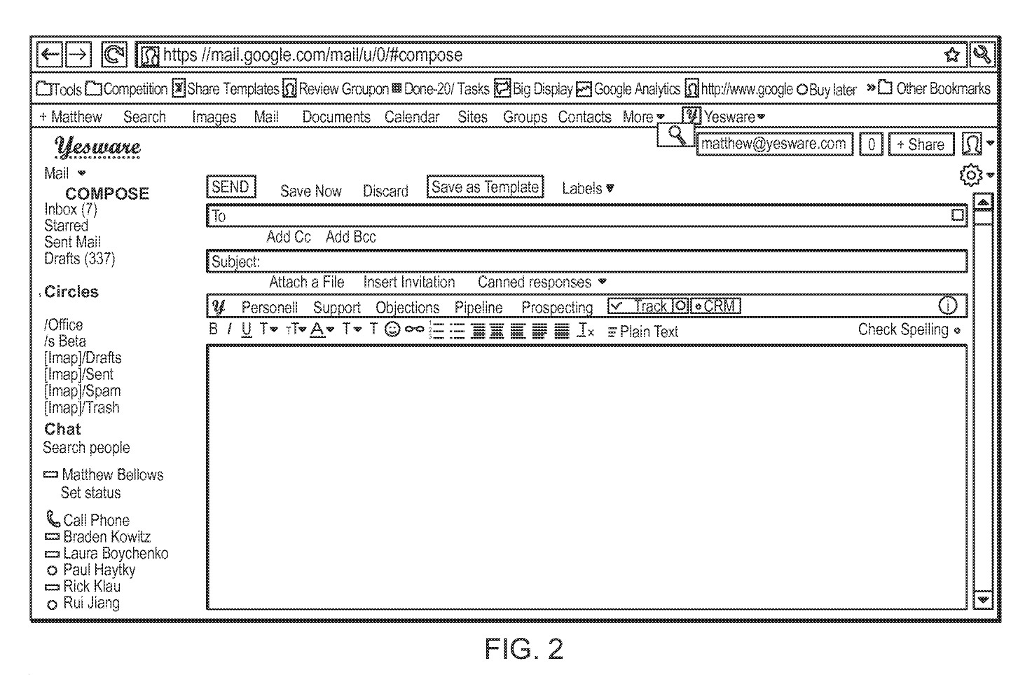

In various embodiments, the CRM system 100 is integrated with a user interface (e.g., an e-mail interface) of an application that facilitates users' daily tasks. Referring to FIG. 2, in one embodiment, the template manager application 108 is loaded and utilized in an e-mail service that facilitates communications between the users and the clients. The e-mail service includes, for example, e-mails accessed through a website or portal, through a dedicated e-mail program running on a desktop or laptop computer, through a mobile device or smartphone, or through other means. The templates stored in the template database 102 may be categorized as different types of e-mails that the users frequently send in performing their business responsibilities. For example, the templates for salespeople can be grouped into categories that correspond to phases of the sales cycle, such as Prospecting, Pipeline, Objections, and Support.

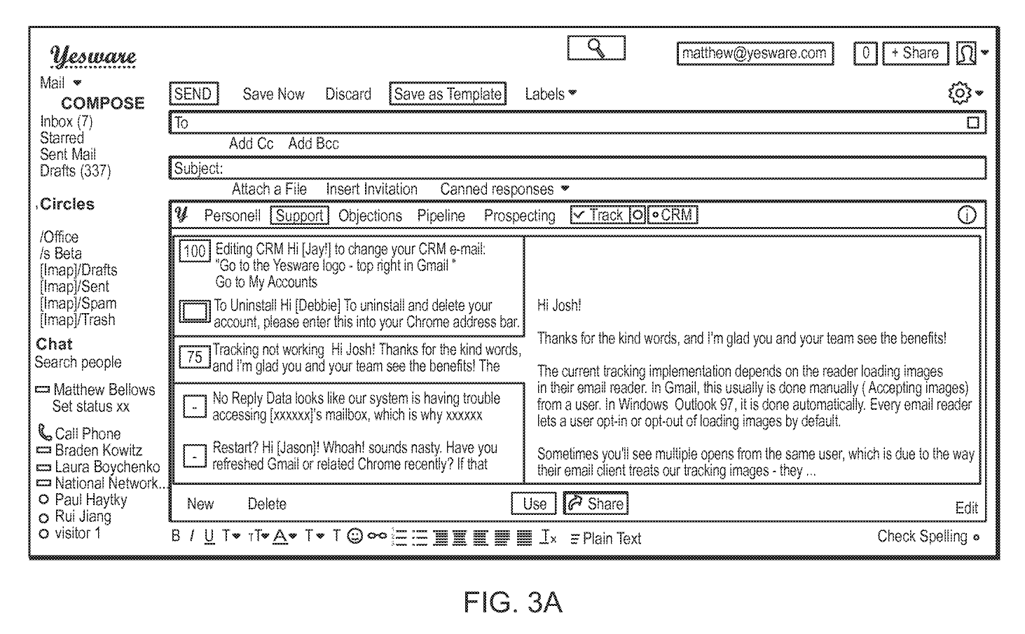

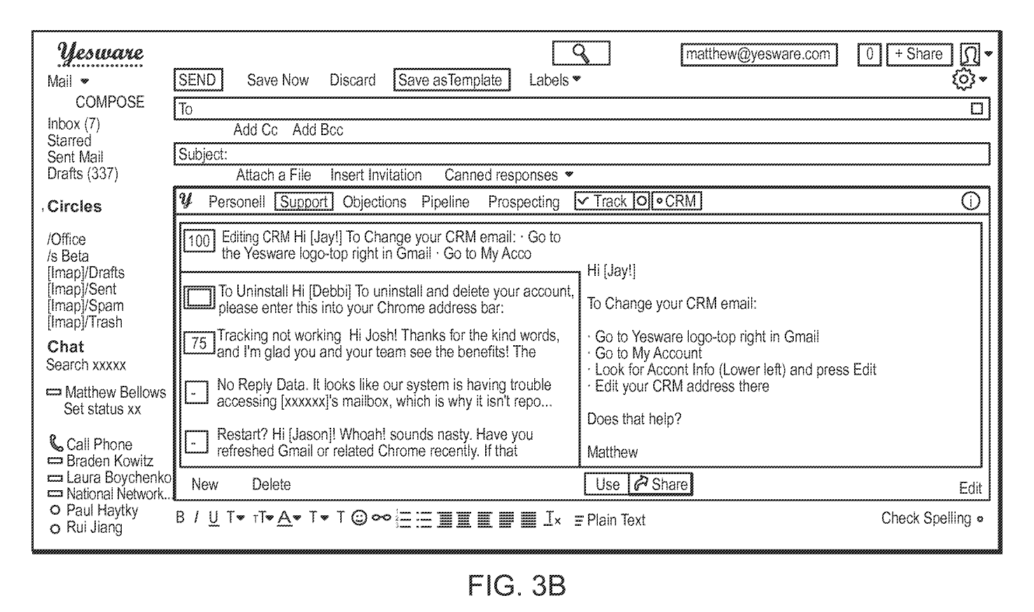

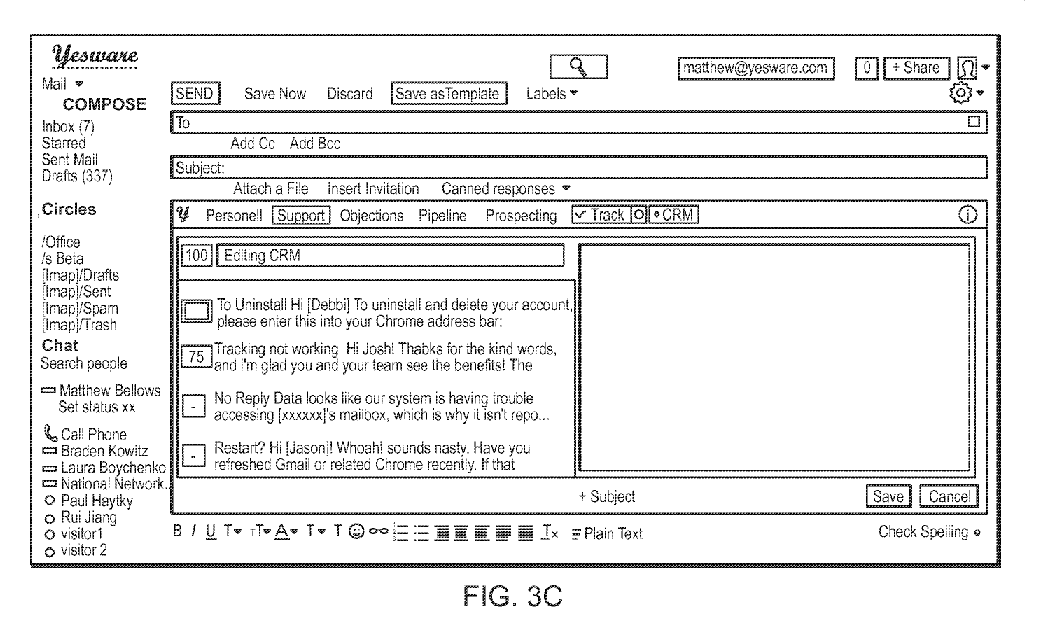

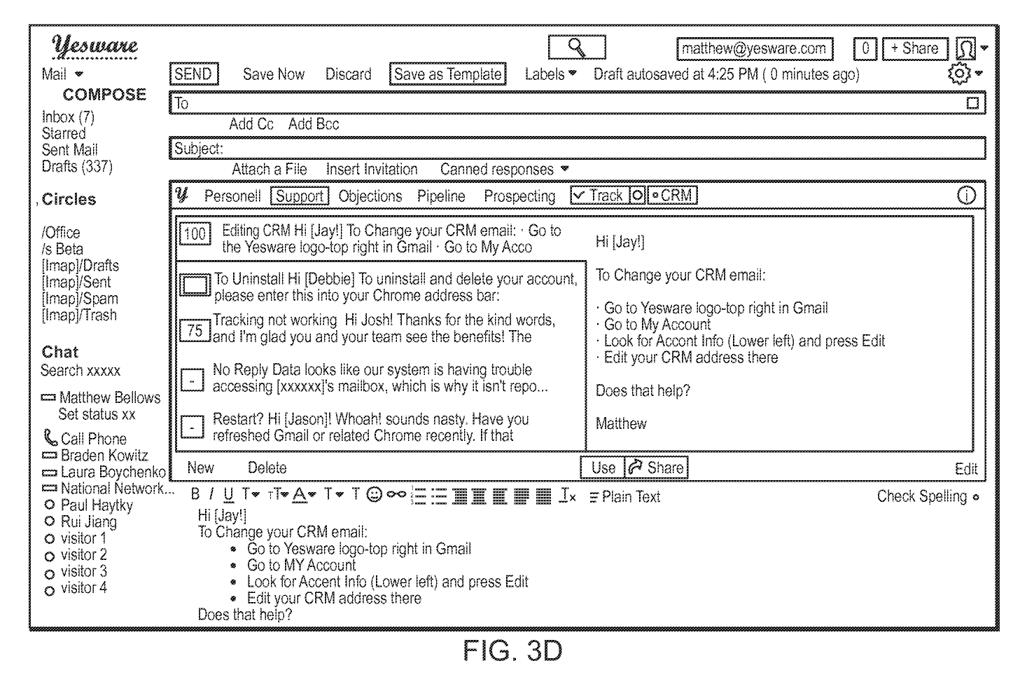

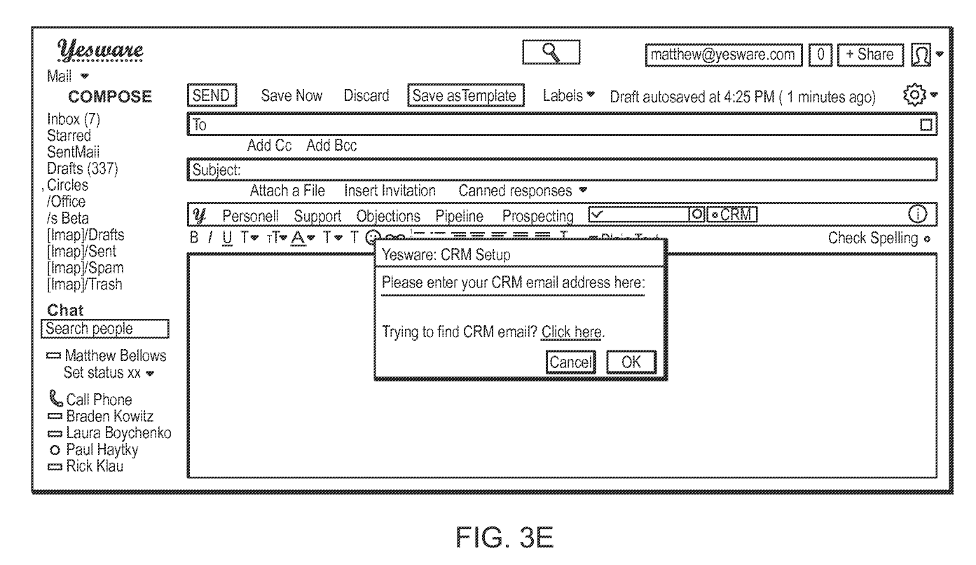

Referring to FIG. 3A, with the template manager application 108 loaded into the communication application, the user is presented with a series of template categories; upon selection of a category, exemplary templates may be presented and listed next to the chosen category. In one embodiment, the template is selected after the user initiates composition of a new e-mail message, i.e., the template is used to format the blank e-mail. In another embodiment, the user selects the template first, and a blank e-mail conforming to the template is generated. In some embodiments, a single window is shown on the screen to display both e-mail and CRM functionalities; this significantly reduces the inconvenience of copying and pasting information between multiple windows or multiple software programs. A graphical input device, such as a keyboard, a mouse, a graphics tablet, or a touchscreen may be used to select the templates. In some embodiments, users are allowed to edit an existing template in order to customize it (FIG. 3B), or create their own templates from scratch (FIG. 3C); the customized or newly generated templates may be stored in the template base 102 and/or the tracking database 104 and shared with other users in the organization. Creating a new template may entail provision of meta-information (e.g., a category) that enables the CRM system to extract meaning or derive reportable information from its use—e.g., associating the template with a particular type of activity. Templates, including user-selected, user-customized, and user-created templates, typically include text fields where the user modifies and/or adds text to tailor the e-mail to the relevant circumstances (FIG. 3D). Text fields may be presented immediately after the corresponding templates are chosen and may be automatically preserved when an e-mail is drafted. In one embodiment, the e-mail cannot be transmitted until all of the text fields from the template have been populated or updated. In some embodiments, the CRM system suggests text based on the nature of the template itself, the recipient (or the recipient's organization), phrases previously chosen or typed by the same user (or other users within the same group), and/or other suitable criteria. Text fields may be completed by, for example, selecting and typing over the content of the text field, using drop-down menus, radio buttons, speech-to-text recognition or spoken commands, or by other means. In some embodiments, the e-mail-based CRM system requires only a few clicks to generate an e-mail conforming to the selected template. With reference to FIG. 3E, in one embodiment, users save templates to an external CRM account (e.g., salesforce.com) in the external CRM database to provide the CRM functionality thereto.

In various embodiments, the user or the CRM system 100 labels the templates with tags or other meta-information that indicates the category of the templates and/or triggers actions or behaviors (e.g., adding recipients to the e-mail, interfacing with other enterprise systems to input and/or query data, or labeling, tagging, or categorizing the e-mail itself) upon selection of the templates. For example, when the user selects a template that schedules an event, the system 100 can automatically formulate an e-mail and add the e-mail address of the user's assistant into the carbon copy (CC) field upon a selection thereof. Similarly, templates that relate to customers' troubles or technical problems may trigger follow-up actions taken or initiated by the system 100, e.g., creating an appropriate support ticket in the responsible department, receiving the ticket number, inserting the ticket number together with the text into the e-mail body, and/or labeling the e-mail with “support.”

The user's selections, customizations, and/or completions of the templates may be stored in the tracking database 104. In one embodiment, the analytical engine 112 automatically or upon request analyzes the stored templates and corresponding logged usage; automated reports can then be generated based on the analysis. Management or leadership personnel at the organization can access the stored data in the tracking database 104 using the administrative interface 110 to obtain information about, for example, user efficiency, customer responsiveness, or strategic initiatives. When a salesperson chooses a template, that person's manager can learn, for example, what stage the customer's account is in, and what the salesperson is currently spending his time on. Because the activity stream for each relationship between user and customer can be monitored and analyzed in real-time, decisions may be made promptly and/or mistakes can be corrected quickly. Additionally, the organization's management may be able to discern trends in the uses, strengths, weaknesses, and sales of their products, or strengths and weaknesses of individual salespeople or teams, by aggregating data across sales teams and company-wide. For example, the analysis engine 112 may assess whether any salespeople within a group or across the organization send e-mails with an “objection” template at a frequency significantly higher than other salespeople; this can indicate a performance problem with the salesperson (or sales group), or problems associated with particular products or customers that the salesperson is responsible for. Again, this analysis may be performed automatically and/or upon request. Analysis of the e-mails themselves, or a greater variety of templates, can provide additional analytical granularity. For example, the analysis engine 112 may assess whether a large percentage of the objection messages relate to price, quality or other factors; the organization can then react accordingly, e.g., reconsidering the pricing structure or better controlling the quality.

In one embodiment, templates stored in the database are managed by individual users; each user can customize and share the templates with other users. In another embodiment, templates are centrally managed, allowing the organization to modify, improve and/or standardize the messages to customers, clients, or others based on the organization's policies or analyzed results from the data stored in the tracking database; this may increase the efficiency of communications and marketing, and encourage the use of “best of breed” and/or “corporate approved” responses.

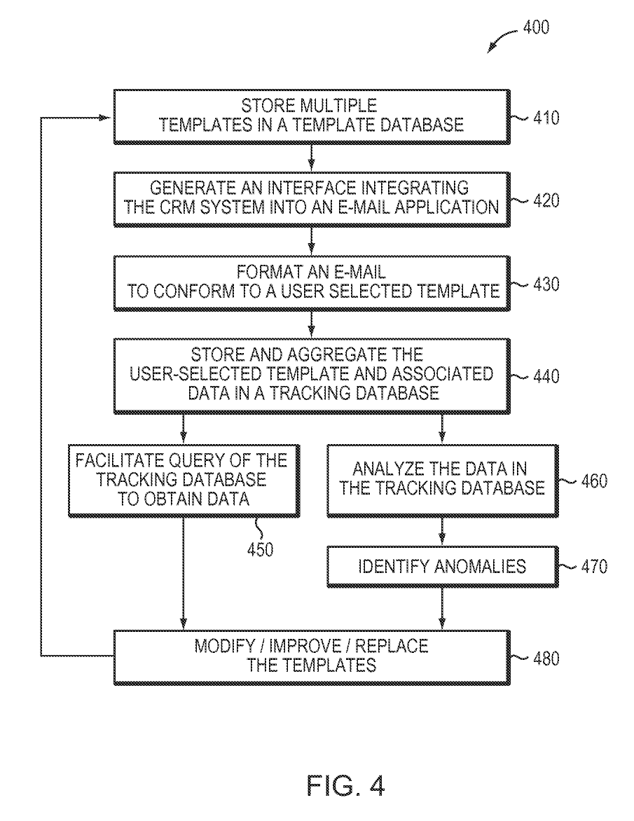

A representative method 400 illustrating the operation and use of an e-mail-based CRM system in accordance with embodiments of the current invention is shown in FIG. 4. In a first step 410, multiple templates corresponding to business activities and including text relating to the business activities are stored in a template database. In a second step 420, a template manager application that generates an integrated user interface is loaded in an e-mail application resident, for example, on a company intranet server; this allows users to access the template database via the e-mail application. In a third step 430, the users select a template and, based on the selection, an e-mail with a format conforming to the selected template is automatically generated. The selected template and corresponding usage is stored and aggregated in a tracking database in a fourth step 440. If the data relating to the users, the business activities and/or the logged usages of the templates at a specified level of aggregation (e.g., a person, a group, an entire organization or a business activity) is of interest to the organization, administration personnel can access the tracking database and obtain this information using an administrative interface (step 450). In addition, an analytical engine may access and analyze the data stored in the tracking database manually or automatically based on the selected templates, business activities associated therewith, and/or the organization's policies (step 460). Based on the analysis, anomalies relating to, for example, a CRM function, a product, a customer, or the user(s) may then be identified (step 470). If necessary, the templates stored in the template database may be customized, modified, improved, and/or replaced by the users or administrators in the organization based on the analysis or policies (step 480).

It should be stressed that the invention is not limited to customer-facing interactions. For example, the e-mail-based CRM system may be used in communications and public relations firms, media outlets, government organizations, private organizations, or other organizations to streamline their communications and facilitate conveying a consistent message.

The analytical engine 112 may be implemented by computer-executable instructions, such as program modules, that are executed by a conventional computer. Generally, program modules include routines, programs, objects, components, data structures, etc. that performs particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The CRM system may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of the system and method of the invention. Rather, any number of different programming languages may be utilized as is necessary or desirable.

The processing and/or the analyzing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit 106 that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place between the processing unit, analytical engine, interfaces and/or databases may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A system for managing customer-relationship activities and knowledge, the system comprising:
a template database for storing a plurality of templates, the templates corresponding to business activities and comprising text relating thereto;
a processor-executed application enabling user selection of a template and formatting of an e-mail, in an e-mail client application, conforming to the template;
a tracking database for storing and aggregating the user template selections; and
an interface for permitting querying of the tracking database to obtain data relevant to at least one user or at least one business activity at a specified level of aggregation.

2. The system of claim 1 further comprising a processor-executed analytical engine for analyzing the user selections and, based on the selections and the business activities associated therewith, identifying anomalies.

3. The system 2 wherein the anomalies relate to a CRM function.

4. The system of claim 3 wherein the anomalies relate to at least one of a product, a customer, a salesperson, or a sales group.

5. The system of claim 1 wherein the template database associates, with each template, at least one tag indicating at least one of a category or an action.

6. The system of claim 1 wherein the specified level of aggregation is a person.

7. The system of claim 1 wherein the specified level of aggregation is a group.

8. The system of claim 1 wherein the specified level of aggregation is an entire organization.

9. The system of claim 1 wherein the specified level of aggregation is a business activity.

10. The system of claim 1 wherein the templates are customizable by a user.

11. The system of claim 1 wherein the templates are customizable by an administrator.

12. The system of claim 1 wherein the e-mail is formatted by applying an e-mail package to the user's e-mail client application.

13. The system of claim 1 further comprising a second interface accessing an external CRM database for providing additional templates to the user.

14. The system of claim 1 further comprising a second interface for accessing an external CRM account in an external CRM database.

15. A method for managing e-mail templates, the method comprising the steps of:
storing a plurality of templates corresponding to business activities and comprising text relating thereto;
enabling user selection of a template and formatting of an e-mail, in an e-mail client application, conforming to the template;
storing and aggregating the user selections; and
facilitating querying of the tracking database to obtain data relevant to at least one user or at least one business activity at a specified level of aggregation.

16. The method of claim 15 further comprising analyzing the user selections and, based on the selections and the business activities associated therewith, identifying anomalies.

17. The method of claim 15 further comprising tagging each template with at least one of a category or an action.

18. The method of claim 15 further comprising accessing an external CRM database for providing additional templates.

19. The method of claim 15 further comprising storing a template in an external CRM account in an external CRM database.

21. The method of claim 15 wherein the e-mail client application comprises a single window displaying the formatted e-mail.
